(19) United States
(12) Patent Application Publication
(10) Pub. No.: US 2020/0294038 A1
(43) Pub. Date: Sep. 17, 2020

(54) SYSTEM AND METHOD FOR EXECUTING TRANSACTIONS ON BLOCKCHAIN NETWORKS

(71) Applicant: GuildOne Inc., Calgary (CA)

(72) Inventors: Barry KREISER, Calgary (CA); James GRAHAM, Calgary (CA); Curtis STANFORD, Calgary (CA); Mike GEE, Calgary (CA)

(73) Assignee: GuildOne Inc., Calgary (CA)

(21) Appl. No.: 16/566,514

(22) Filed: Sep. 10, 2019

Related U.S. Application Data
(60) Provisional application No. 62/730,190, filed on Sep. 12, 2018.

(51) Int. Cl. G06Q 20/38; G06Q 20/22; G06Q 20/06

(52) U.S. Cl. CPC G06Q 20/389; G06Q 20/0658; G06Q 20/223

(57) ABSTRACT

There is disclosed a system and method for executing multifaceted, multiparty transactions on a Blockchain network. In an aspect, there is disclosed a computer system which, together with other computer systems, participates as a node in a distributed Blockchain network. Each of the computer systems participating as a node in the Blockchain network and participating in a multifaceted, multiparty transaction includes storage adapted to store one or more data models required for modeling the multifaceted transaction between multiple parties participating in the Blockchain network, and a processor for dynamically instantiating the one or more data models to execute the multifaceted, multiparty transaction.

### FIELD OF THE INVENTION

The present disclosure relates generally to blockchain distributed ledger networks, and more generally to a system and method for executing transactions thereon.

### BACKGROUND

Blockchain networks provide a peer-to-peer network of nodes which carry out a variety of tasks to maintain a digitized, decentralized, distributed ledger of transactions called a blockchain. Starting with a genesis block, the blockchain comprises a chronological chain of linked blocks which together provide an immutable record of all transactions that have taken place between various parties participating in the blockchain network.

While blockchain technology has been initially adapted for various purposes such as the development of cryptocurrencies and recording currency transactions, the use of blockchains for executing more complex, multifaceted multiparty transactions is still undergoing development.

What is needed is an improved system and method for modeling and executing more complex, multifaceted multiparty transactions on blockchain technologies.

### SUMMARY

The present disclosure relates generally to the field of blockchain distributed ledger networks, and more generally to a system and method for executing multifaceted, multiparty transactions thereon.

In one aspect, there is disclosed a computer system which, together with other computer systems, participates as a node in a blockchain distributed ledger network. Each of the computer systems participating as a node in the blockchain network and participating in a multifaceted, multiparty transaction includes storage adapted to store one or more data models required for modeling the multifaceted transaction between multiple parties participating in the blockchain network, and a processor for dynamically instantiating the one or more data models to execute the multifaceted, multiparty transaction.

In an embodiment, the multifaceted, multiparty transaction is a contractual agreement between the parties, and data models generated from a contract template which define the blueprint or prototype from which contracts are modelled. The data models built from the contract template encompass contract meta-data, formulas for various calculations such as royalties or interest payments, and various triggering events which may trigger a transaction between the parties. The data models thus fully reflect the results of a negotiated agreement between the parties, and is recorded in the blockchain to provide a persistent, immutable record of all of its terms.

In another embodiment, event templates stored by the system define and constrain a set of facts for which the contract template can define formulas that generate results when an event conforming to the template issued.

In another embodiment, the data models stored by the system include formulas agreed upon between the parties, and which are recorded into the blockchain. Based on the triggering events modeled into the contract data models, the results of the formulas are used to trigger additional contractual terms based on the configuration. As the contract data models are modeled to provide a multifaceted, multiparty model, a plurality of contract counter-parties on various computer systems connected to the blockchain network may receive transactions resulting from the execution of formulas.

In another embodiment, the formulas which generate payment obligations in the system may be settled with a digital currency which is connected to the system and available to all participating parties.

In another aspect, there is provided a computer-implemented method of executing multifaceted, multiparty transactions by generating one or more data models required for modeling the multifaceted transaction between multiple parties participating on computer system nodes in the blockchain network.

In an embodiment, the method further comprises storing the one or more data models on storage provided with each participating computer system node, and initiating dynamic instantiation of the one or more data models on the participating computer system nodes to execute the terms of a negotiated agreement between the parties.

In this respect, before explaining at least one embodiment of the invention in detail, it is to be understood that the invention is not limited in its application to the details of construction and to the arrangements of the components set forth in the following description or the examples provided therein, or illustrated in the drawings. Therefore, it will be appreciated that a number of variants and modifications can be made without departing from the teachings of the disclosure as a whole. Therefore, the present system, method and apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present system and method wilt be better understood, and objects of the invention will become apparent, when consideration is given to the following detailed description thereof. Such description makes reference to the annexed drawings, wherein:

FIG. 1A shows a schematic diagram of a system in accordance with an embodiment.

FIG. 1B shows a contract party system from the perspective of a computer system participating as a node.

FIG. 2A shows a schematic diagram showing component relationships in accordance with an embodiment.

FIG. 2B shows a corresponding state model diagram in accordance with an illustrative embodiment.

FIG. 3A shows an illustrative contract template in a GUI on one of the computer systems that is generated dynamically from the contract template.

FIG. 3B shows an illustrative validation error for each invalid fact.

FIG. 3C shows an illustrative screen shot of a contract event being entered into a GUI of a computer system.

FIG. 4A shows an illustrative of a GUI on a computer system for a contracting process.

FIG. 4B shows an illustrative contract drafting process in accordance with an embodiment.

FIG. 4C shows an illustrative contract proposal process in accordance with an embodiment.

FIG. 4D shows an illustrative contract approval process in accordance with an embodiment.

FIG. 4E shows an illustrative contract rejection sequence in accordance with an embodiment.

FIG. 4F shows an illustrative contract change request in accordance with an embodiment.

FIG. 4G shows an illustrative event issuance process in accordance with an embodiment.

FIG. 4H shows an illustrative contract execution flow diagram in accordance with an embodiment.

FIG. 5 shows a schematic block diagram of a generic computing device which may provide an operating environment for various embodiments.

In the drawings, embodiments are illustrated by way of example. It is to be expressly understood that the description and drawings are only for the purpose of illustration and as an aid to understanding, and are not intended as describing the accurate performance and behavior of the embodiments and a definition of the limits of the invention.

### DETAILED DESCRIPTION

As noted above, the present invention relates to the field of blockchain distributed ledger networks, and more generally to a system and method for executing multifaceted, multiparty transactions thereon.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

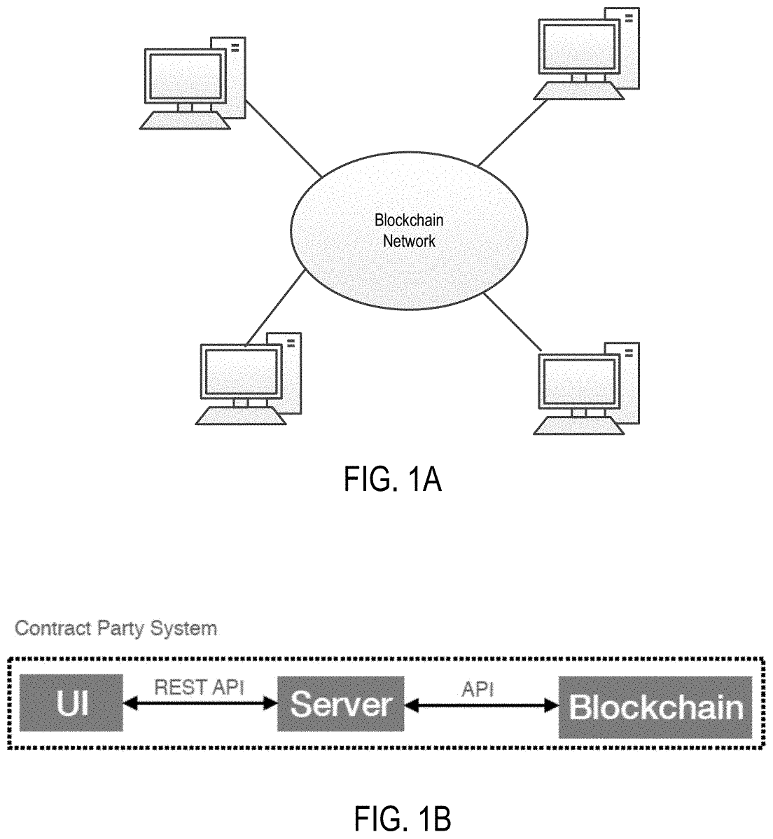

Referring to FIG. 1A, a plurality of computer systems participate as nodes in a distributed blockchain network. Each of the computer system nodes in the blockchain network which participate in a multifaceted, multiparty transaction includes storage adapted to store one or more data models required for modeling the multifaceted transaction between multiple parties participating in the blockchain network, and a processor for dynamically instantiating the one or more data models to execute the multifaceted, multiparty transaction.

FIG. 1B illustrates a view of the system from one of the computer systems participating as a node, with a UI, a Server, and the blockchain. The UI provided at each node may be a CLI (Command Line Interface), a GUI (Graphical User Interface), or both. The permissioned blockchain connects participants together in a peer-to-peer and secure network only sharing data between parties to a contract. Unlike prior art smart-contract systems, this system stores the description of the smart contract on the blockchain rather than expressing it as a programming language. These descriptions of the contracts and the events that trigger them are referred to as “Contract Templates” and “Event Templates” respectively in the system, as described in further detail below.

Still referring to FIG. 1B, using this methodology, the system avoids having to take the network down to distribute new functionality and is able to rapidly author new contract types to support various contract terms for royalty agreements. The “Server” supports a REST API for third party connectivity.

The multifaceted, multiparty transaction is a contractual agreement between the parties, where the parties need to come to an agreement with each other even though they may not completely trust each other. Electronic solutions to this problem can involve blockchain or distributed ledger products. Data models for the multiparty contract are generated from a contract template which define the blueprint or prototype from which contracts are modelled. The data models built from the contract template may encompass contract meta-data, formulas for various calculations such as royalties or interest payments, and various triggering events which may trigger a transaction between the parties. The data models thus fully reflect the results of a negotiated agreement between the parties, such as an agreement on splitting fractional or percentage royalty payments between the parties, and is recorded in the blockchain to provide a persistent, immutable record of all of its terms. The contract template is adaptable to different types of industries and markets, without re-writing any computer code (e.g. oil/gas industry, film industry, music industry, etc.).

In an embodiment, the system is configured to track the splitting of fractional or percentage payments between the parties over multiple transactions, and where the splitting of payments by fraction or percentage results in a rounding up or rounding down of payments to one or more of the parties to achieve a total of 100%, the cumulative payments to each party are tracked by the system to ensure that each party to the contact is paid an appropriate fraction or percentage over the term of the contract. The immutable records of the terms of the contract and the periodic fractional or percentage payment transactions to each party allow the payments to be tracked accurately by the system down to the last fraction of a cent.

In an illustrative embodiment, the system and its functions are insulated and adaptable to different blockchain and distributed ledger platforms with minimal effort. The system also models to be as generic and reusable as possible without sacrificing ease of use or functionality. These novel approaches, as summarized in Table 1 below, enable the system to solve the problem of creating a flexible, powerful and secure royalty execution and settlement solution.

Further details are provided in the attached Appendix A, which is incorporated by reference herein in its entirety.

TABLE 1

| Function | Typical Solutions | Our Solution |
|---|---|---|
| Interface to | Direct connection between clients | Intermediate server that connects |
| Ledger | and blockchain/ledger, making | to blockchain/ledger and presents |
| | changes difficult and more | a consistent, ledger - neutral API |
| | extensive. | to clients. |
| Contract Model | Contracts created with code | A generic model of templates and |
| | containing a strict schema that | facts allowing use in many markets |
| | requires a programmer and | and use cases. Also, |
| | redeployment to change. | nonprogrammers can create |
| | | templates and deploy without |
| | | disruption. |
| Event Model | Events are hardcoded to work with | Events also have templates that |
| | the static contracts in the system. | can be created by |
| | | nonprogrammers and deployed |
| | | easily. |
| Event | Contract and event specific code is | Events are matched to contracts |
| Processing | used to find contracts that need | using DSL expressions and results |
| | processing and to generate contract | are generated using formulas |
| | specific results. | specified in the contract template's |
| | | event handler. Processing code is |
| | | generic and never needs changing |

### The Template Concept

In an embodiment, the system and method utilizes various templates to define the multifaceted, multiparty relationship. A template is a blueprint which defines and constrains a set of “facts” which describe what information is needed for a particular contract. Table 2 below shows an abbreviated example of facts:

TABLE 2

| Name | Label | Description | Type | Validations |
|---|---|---|---|---|
| effective_date | Effective | Effective date | Date/Time | value >= now |
| | Date | of the contract | | |
| allocation | Allocation | Allocation | Percentage | value >= 0 and |
| | | of product | | value <= 100 |
| price | Price | Price of product | Float | value > 0 |

Facts are a description of required data but not the actual data itself. Each fact can have other attributes like default value, GUI layout options and tags.

Each fact can also have 0 or more validations which are parsed and executed using DSL (domain specific language) which is designed to make it simple for non-programmers to specify validations and formulas (described later on). Validations can also be specified at the template level if we need to have a validation involving multiple facts.

Using these templates, the system GUI can automatically and dynamically create a form that a user can use to fill in the values for each of the facts and, because of the validations, be sure that the contract or event they have entered is valid.

Non-programmers can easily create these templates and they can be shared with other users on the network. New ones can be added without changing any computer code or restarting any blockchain nodes on the network.

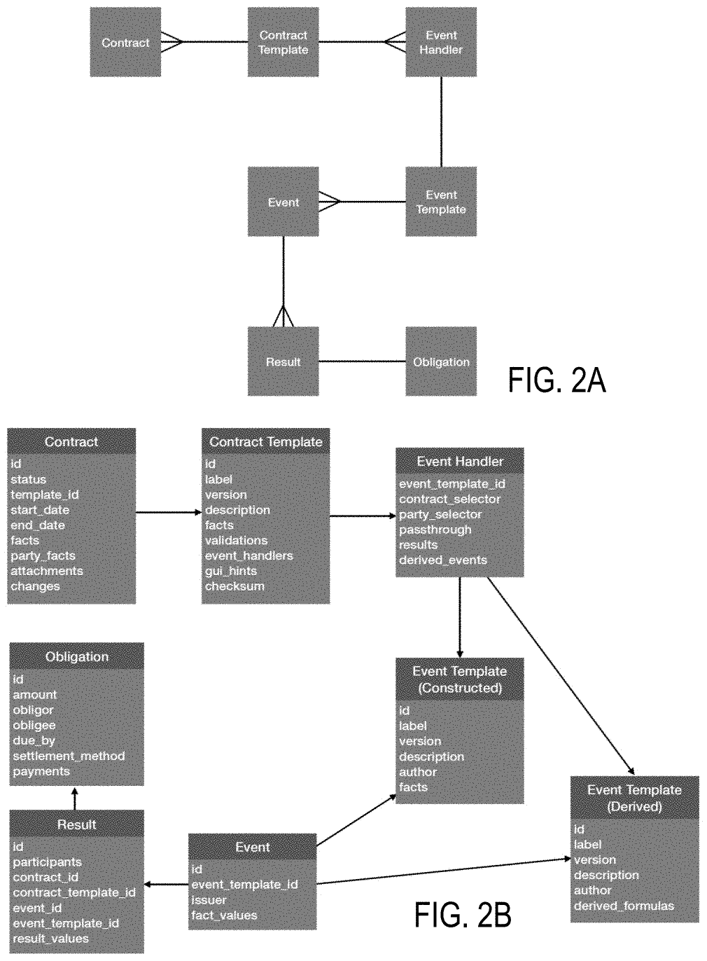

Now referring to FIGS. 2A and 2B, schematic diagrams show component relationships and a state model for the various components and their relationships as described below.

Contract Templates

A multifaceted, multiparty contract is modeled using a Contract Template. The Contract Template defines and constrains a set of Facts expected to be provided (i.e. defined) at contract creation. There are two classes of Facts defined in a Contract Template—those which apply to all of the parties in a contract (Contract Facts), and those which may differ for each party to the contract (Party Facts).

As an illustrative example, for an oil/gas fixed royalty contract, the Contract Template may define the following Facts:
Contract Facts=>Effective Date, Expiry Date, Allocation Percent
Party Facts=>Royalty Percentage, Payor Percentage, Payee Percentage

The Contract Template also includes Event Handlers which associate Event Templates (discussed further below) with the Contract Template. The Event Handlers define the formulae which are run when the contract is executed. The formulae are executed in the context of the defined Contract Facts, Party Facts and Event Facts, and will produce Contract Results. The association between Event Templates and the Contract Template defines how results are generated when contracts matching the event are executed. Different types of Event Handlers can be plugged in to extend the system and generate new types of results.

In an embodiment, a Contract Template is made up of a label, description, author, creation date, facts, party facts, party tags, event handlers and validations. A contract instance is what you get when values are supplied to all of the parts of the contract template.

a) Label

The label is used in the GUI or CLI to allow the user to pick from a list of contract templates when creating a contract instance.

b) Description

Allows the template author to describe the contract template for other users or authors.

c) Author

Records which party on the network authored the contract template.

d) Creation Date

Records when the contract template was created.

e) Facts

Using the fact concept describe previously, a series of facts are specified that are required to be provided with a valid value when creating a contract instance.

f) Party Facts

This part of the contract template specifies which facts are required for each party of the contract. Since royalty contracts are usually between two or more parties, the party facts are values that pertain to each party.

g) Party Tags

Each party may need to be distinguished from other parties as they may have different functions or roles in the contract. A party tag is a simple keyword that each party can be associated with. Each party can be tagged with 0 or more party tags. These tags can be used in validations or formulas later on.

h) Event Handlers

A contract by itself is not terribly useful. An event handler allows the contract to handle and process different types of events when they are issued into the network. A contract template can specify 0 or more event handlers. Each event handler specifies the type of event it can handle, a contract selector expression, a party pair selector expression, a list of formulas with which to generate results and a list of 0 or more derived event templates.

i) Validations

Any validation that involves more than 1 fact value can be specified here. For example, if the sum of 3 fields in a contract needs to add up to 100, a validation of “f1+f2+f3=100” can be specified. All contract validations, whether they're from facts, party facts or the contract template itself are executed and checked before a contract can be proposed into the system.

Table 3, below, shows an illustrative example of a contract template.

TABLE 3

| | | | |
|---|---|---|---|
| Label | Fixed Royalty Contract | | |
| Description | Describes fixed royalty | | |
| | relationships on an | | |
| | asset | | |
| Author | Party A | | |
| Creation Date | Sep. 1, 2018 | | |
| Facts | name | Name of contract | Text |
| | contract_type | Type of contract | Choice of LOR or GOR |
| | product | Product produced | Choice of Gas or Oil |
| | encumbrance | Production | Percentage |
| | | Encumbrance | |
| | allocation | Allocation Percent | Percentage |
| Party Facts | royalty_interest | Royalty interest | Percentage |
| | Payor_share | Payor Share | Percentage |
| Party Tags | payor | | |
| | payee | | |
| | producer | | |
| Event Handlers | I handle well production | I create a result with a | |
| | events | royalty_amount value | |
| | | calculated with specified | |
| | | formula | |
| Validations | encumbrance + | | |
| | allocation <= 100 | | |
| | must be 2 or more | | |
| | parties | | |
| | must be 1 or more | | |
| | parties marked as payor | | |
| | must be 1 or more | | |
| | parties marked as payee | | |
| | payor_share of parties | | |
| | marked as payor must | | |
| | add up to 100 | | |
| | royalty_interest of parties | | |
| | marked as payee must | | |
| | add up to <= 100 | | |

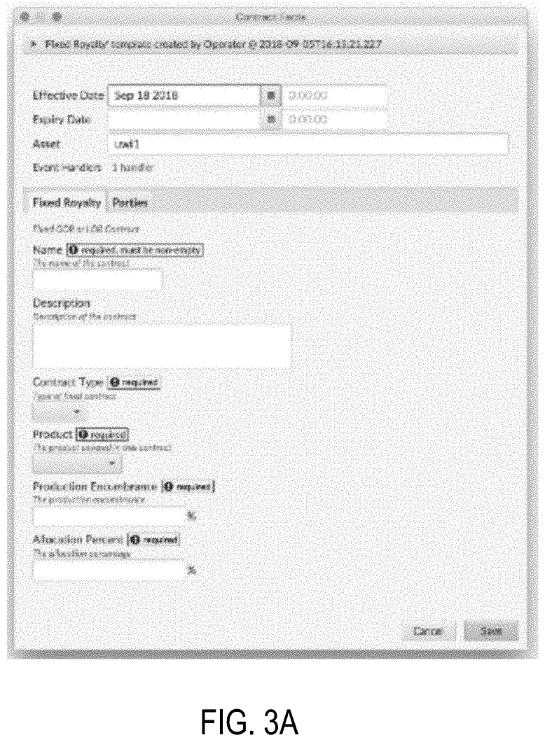

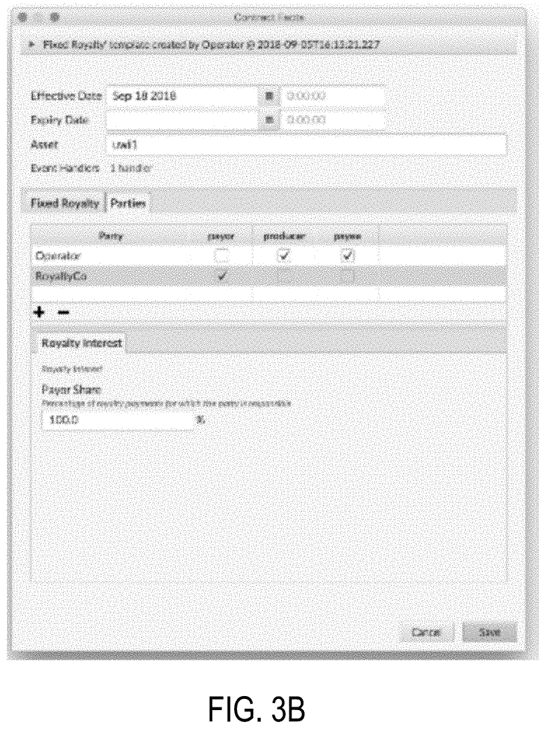

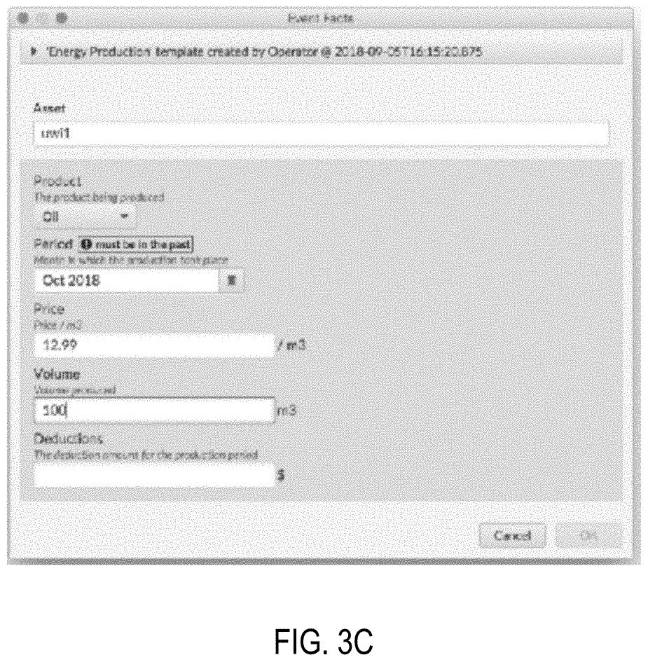

FIG. 3A shows an illustrative contract template in a GUI on one of the computer systems that is generated dynamically from the contract template. FIG. 3B shows an illustrative validation error for each invalid fact. Here, the screen shows the parties of the contract and, to their right, the tags associated with each party. Tags can dictate which facts show for the party. For example, parties with the “payor” tag see the “Payor Share” fact and parties with the “payee” tag see the “Royalty Interest” fact.

Event Templates

As noted earlier, the other main entity in the system is an event. Events are issued into the system and contracts which handle the event are executed to generate results. Events, like contracts, have templates which describe what information is needed for a certain event.

Event templates define and constrain a set of facts for which the contract template can define formulas that generate results when an event conforming to the template issued. Users can create as many event templates (or types) as they need.

There are two types of event templates: constructed and derived. Constructed events are created by external users or systems and issued into the system. Derived events are created during the processing of an event when an event handler specifies that it would like to create more events as a result of handling another event. Both event templates consist of a label, description, author, and creation date. These have the same function as the same attributes in a contract template.

Constructed event templates also consist of a list of facts and validations. The facts describe what information is needed to construct an event instance. The validations describe checks that need to be performed on the facts within the event.

Derived event templates have no facts but consist of a list of formulas that are executed in the context of a contract, event and result during event processing.

TABLE 4

| | | | |
|---|---|---|---|
| Label | Well Production | | |
| Description | Describes production | | |
| | of a product from an | | |
| | asset | | |
| Author | Party A | | |
| Creation date | Sep. 1, 2018 | | |
| Facts | product | Product produced | choice of |
| | | | Oil or Gas |
| | period | Month of production | Year/Month |
| | price | Price per unit of | Float |
| | | product sold | |
| | volume | Volume of product | Float |
| | | sold | |
| | deductions | Deductions from total | Float |
| | | amount for royalties | |
| Validations | period < now | | |
| | price > 0 | | |
| | volume > 0 | | |

Table 4, above, provides an illustrative example of a Constructed Event Template.

A corresponding screen shot am event being entered into a GUI of a computer system is shown in FIG. 3C.

Table 5, below, shows an illustrative example of a Derived Event Template.

TABLE 5

| | | |
|---|---|---|
| Label | Royalty Paid | |
| Description | Describes a royalty | |
| | that was paid | |
| Author | Party A | |
| Creation date | Sep. 1, 2018 | |
| Formulas | royalty_paid | result_royalty_amount |
| | payor | result_payor |
| | payee | result_payee |

Contracting Process

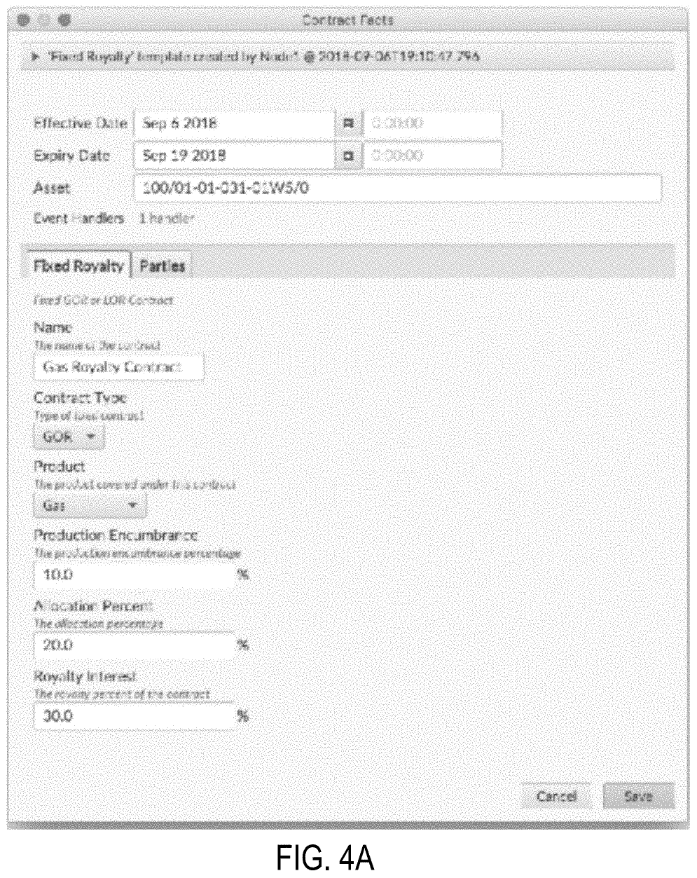

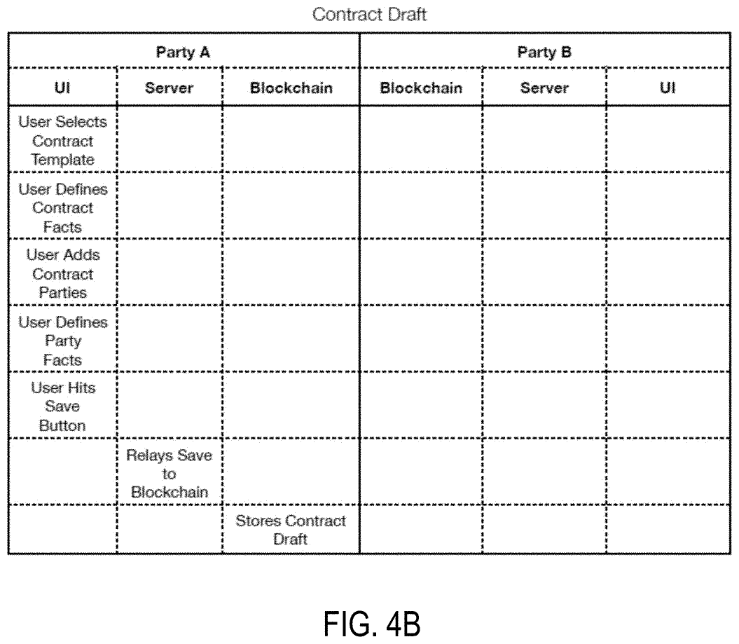

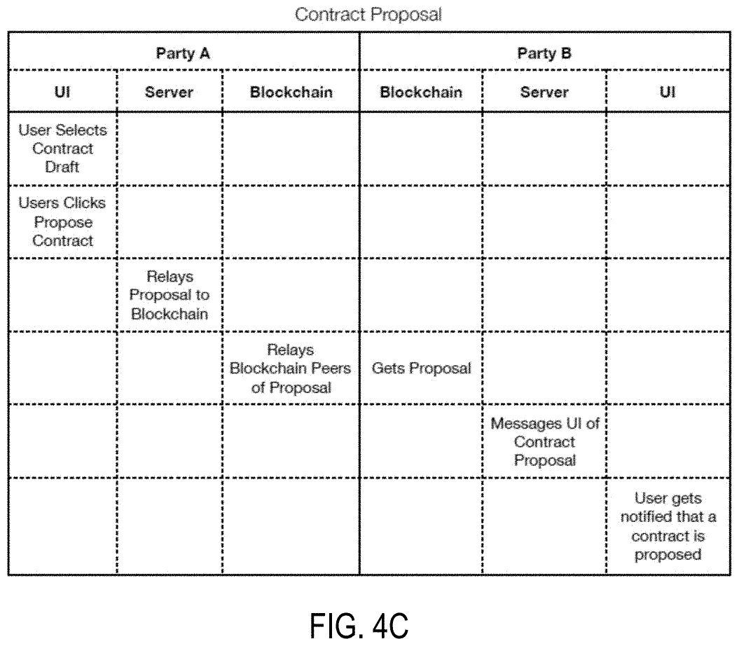

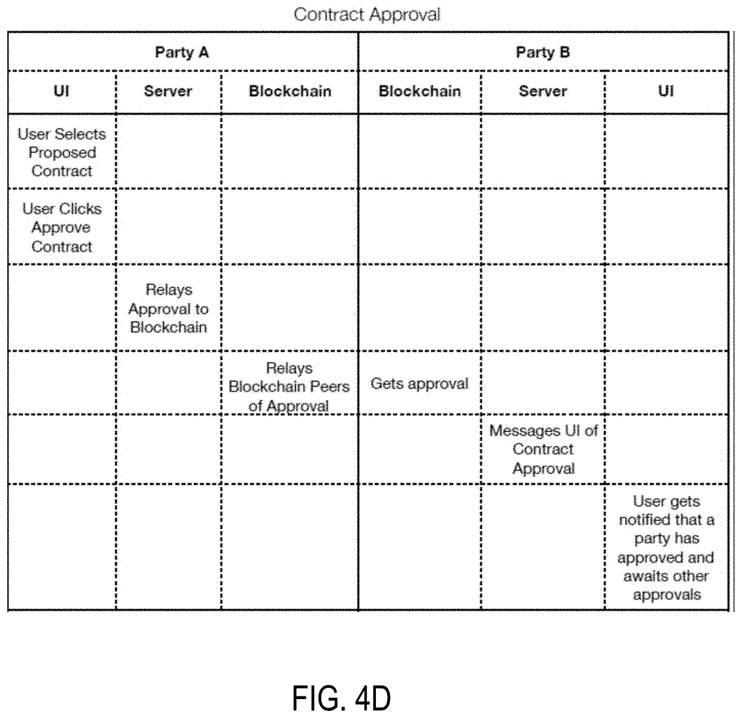

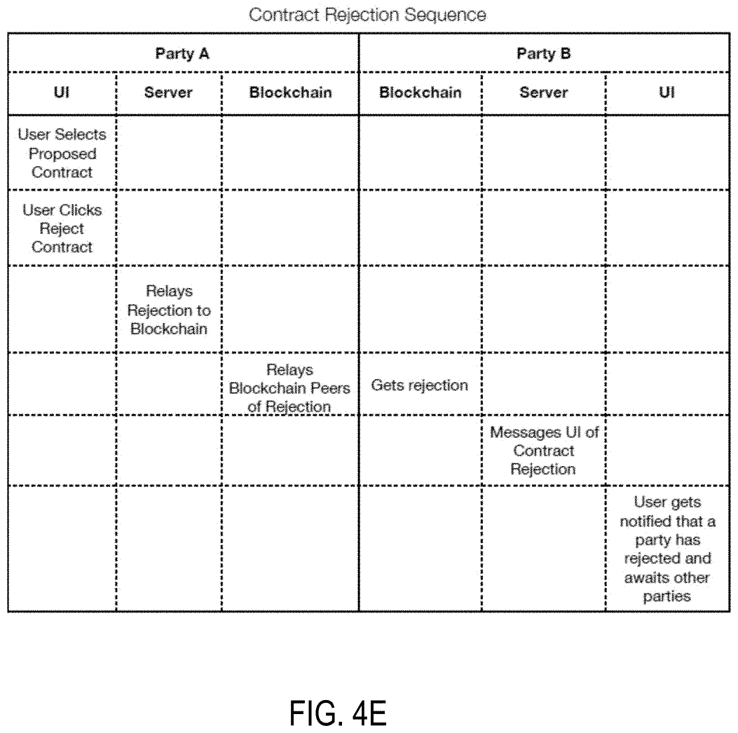

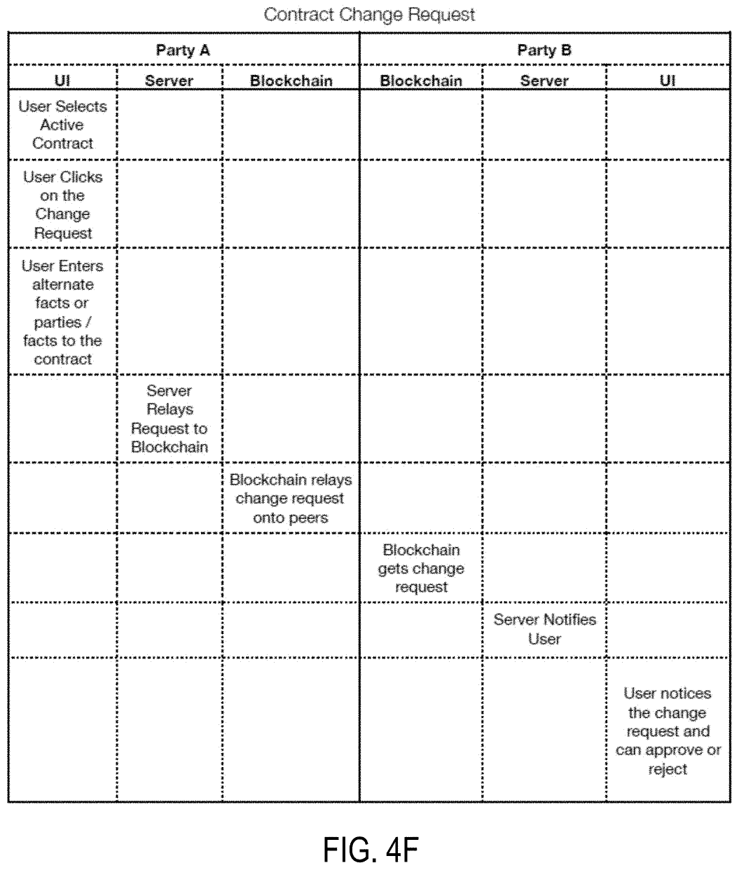

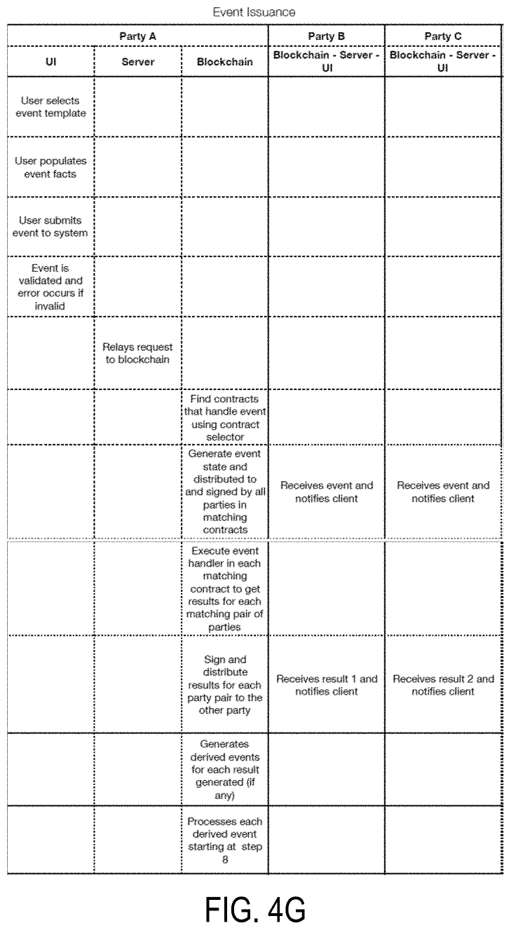

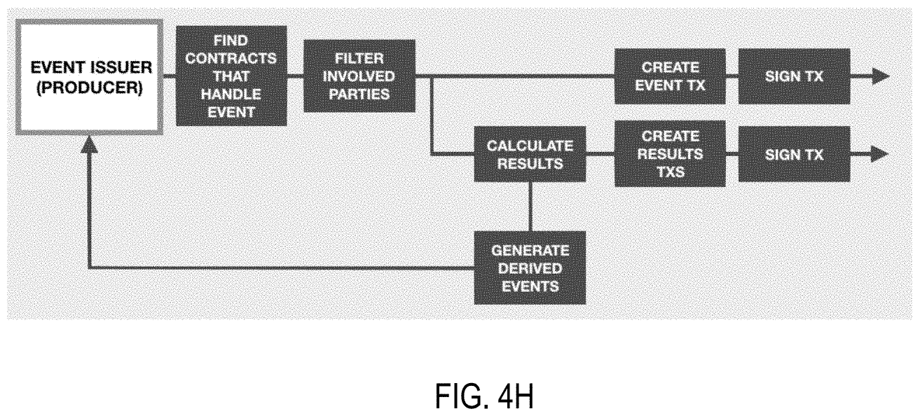

Creating a contract draft is the process through which a user chooses a contract template and enters the values for the facts. This process can be performed for a single contract or for multiple through a batch process. FIG. 4A shows an illustrative of a GUI on a computer system for a contracting process. A corresponding process is shown in FIG. 4B.

After a party has a contract draft and they are satisfied that it is representative of the agreed contract terms, they propose the contract to all of the parties. An illustration of the contract proposal process is shown in FIG. 4C.

After a party has been notified of a contract proposal, they can opt to approve the contract. FIG. 4D illustrates a sequence by which a contract gets approved by a party.

After a party has been notified of a contract proposal, they can opt to reject the contract. FIG. 4E shows a sequence by which a contract gets rejected by a party.

On an approved/active contract a party can initiate a change request on the contract. When the change request is initialized it will have to be agreed on by all parties in the contract before it is effective. Shown in FIG. 4F is the sequence of contract change request.

Events can be issued through the server API or by using the GUI. The facts in an event and the event itself are validated before submitting to the system. FIG. 4G illustrates an event issuance sequence. This process can generate infinite cycles of derived events generating more derived events of the same kind over and over again. This is checked for and prevented at the blockchain level.

The overall contract execution flow is shown in FIG. 4H. The genesis of contract execution is an event being issued. After the event has been issued, the system matches the contracts and calculates the results. Results may generate derived events which would then also execute using the same technique.

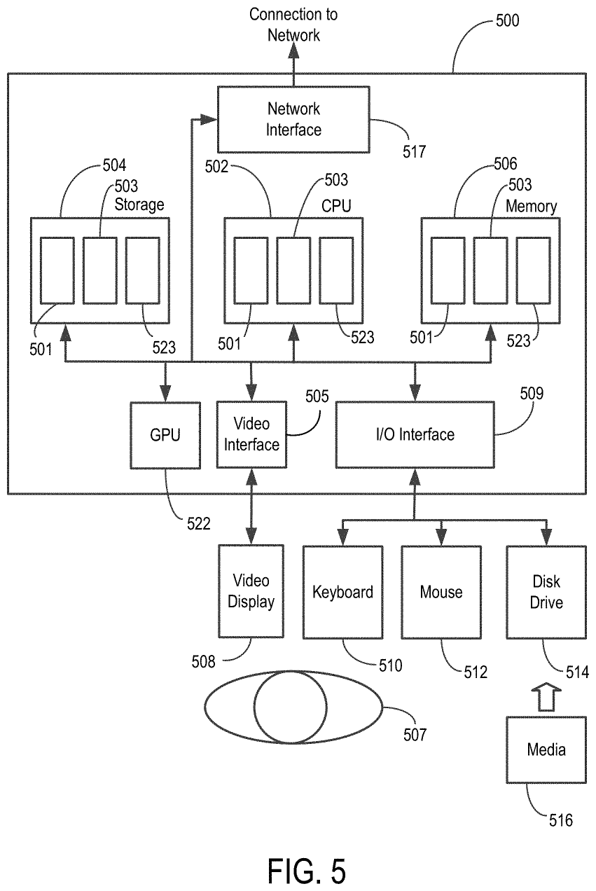

Now referring to FIG. 5 shown is a schematic block diagram of a generic computing device that may provide a suitable operating environment in one or more embodiments. A suitably configured computer device, and associated communications networks, devices, software and firmware may provide a platform for enabling one or more embodiments as described above. By way of example, FIG. 5 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run these calculations in parallel with CPU 502. An operator 510 may interact with the computer device 500 using a video display 508 connected by a video interface 505, and various input/output devices such as a keyboard 510, pointer 512, and storage 514 connected by an I/O interface 509. In known manner, the pointer 512 may be configured to control movement of a cursor or pointer icon in the video display 508, and to operate various graphical user interface (GUI) controls appearing in the video display 508. The computer device 500 may form part of a network via a network interface 511, allowing the computer device 500 to communicate with other suitably configured data processing systems or circuits. A non-transitory medium 516 may be used to store executable code embodying one or more embodiments of the present method on the generic computing device 500.

In summary, the system and method provides a multifaceted, multiparty contract modeling and processing solution with one code base handles and generates results for any combination of events and contracts.

The system is built at a functional level of abstraction, and is not dependent upon any single blockchain or distributed ledger platform. By utilizing a template model with Domain Specific Language, the system provides greater flexibility and power to model different contracts.

A multifaceted multiparty contact draft, negotiation, and execution can thus be digitized, and any disputes between the participating parties are minimized as they all share the same data model and dataset via the blockchain network. This results in significant faster royalty contract calculations to generate payment obligations which may be settled with a digital currency connected to the system and available to all participating parties.

Thus, in an aspect, there is provided a system for executing multifaceted, multiparty transactions on a blockchain distributed ledger network, comprising: a plurality of computer systems participating as nodes in the blockchain distributed ledger network, each system including: storage adapted to store the blockchain distributed ledger and one or more data models required for modeling the a multifaceted multiparty transaction within the blockchain distributed ledger network; and a processor for dynamically instantiating the one or more data models on participating computer system nodes to execute the multifaceted, multiparty transaction.

In an embodiment, the one or more data models are built from contract templates defining contract meta-data and formulas for calculations, and event templates defining triggering events which initiate a transaction between the multiple parties.

In another embodiment, the system is further configured to record the triggering and execution of each multifaceted, multiparty transaction as an immutable record in each instance of the blockchain distributed ledger network stored in each participating computer node.

In another embodiment, the system is configured to store the one or more data models as immutable records within the blockchain distributed ledger.

In another embodiment, the blockchain distributed ledger is permissioned to connect the multiple parties in a secure peer-to-peer network, and configured to share the one or more data models between the multiple parties to a contract defined by the one or more data models.

In another embodiment, the multifaceted, multiparty transaction is a contractual agreement between requiring a payment transaction between multiple parties.

In another embodiment, the payment transaction is one of a royalty payment and an interest payment, and any splitting of fractional or percentage payments as between the multiple parties are predefined by the one or more data models.

In another embodiment, the system is configured to initiate the payment transaction and any splitting of fractional or percentage payments between the multiple parties as defined by the one or more data models upon occurrence of a triggering event defined by the event template.

In another embodiment, the system is configured to automate the payment transaction upon occurrence of a triggering event and record the payments as immutable records in each instance of the blockchain distributed ledger of each participating computer node.

In another embodiment, the system is configured to settle any payment obligations between the multiple parties with a digital currency which is connected to the system and available to all participating parties.

In another aspect, there is provided a computer-implemented method of executing multifaceted, multiparty transactions on a blockchain distributed ledger network, comprising: for each computer system participating as a node in the blockchain distributed ledger network, storing in storage the blockchain distributed ledger and one or more data models required for modeling a multifaceted multiparty transaction within the blockchain distributed ledger network; and utilizing a processor of one more computer system participating as a node in the blockchain distributed ledger network, dynamically instantiating the one or more data models on participating computer system nodes to execute the multifaceted, multiparty transaction.

In an embodiment, the one or more data models are built from contract templates defining contract meta-data and formulas for calculations, and event templates defining triggering events which initiate a transaction between the multiple parties.

In another embodiment, the method further comprises recording the triggering and execution of each multifaceted, multiparty transaction as an immutable record in each instance of the blockchain distributed ledger network stored in each participating computer node.

In another embodiment, the method further comprises storing the one or more data models as immutable records within the blockchain distributed ledger.

In another embodiment, the method further comprises permissioning the blockchain distributed ledger to connect the multiple parties in a secure peer-to-peer network, and sharing the one or more data models between the multiple parties to a contract defined by the one or more data models.

In another embodiment, the multifaceted, multiparty transaction is a contractual agreement between requiring a payment transaction between multiple parties.

In another embodiment, the payment transaction is one of a royalty payment and an interest payment, and any splitting of fractional or percentage payments as between the multiple parties are predefined by the one or more data models.

In another embodiment, the method further comprises initiating the payment transaction and any splitting of fractional or percentage payments between the multiple parties as defined by the one or more data models upon occurrence of a triggering event defined by the event template.

In another embodiment, the method further comprises automating the payment transaction upon occurrence of a triggering event and recording the payments as immutable records in each instance of the blockchain distributed ledger of each participating computer node.

In another embodiment, the method further comprises settling any payment obligations between the multiple parties with a digital currency which is connected to the system and available to all participating parties.

While illustrative embodiments have been described above by way of example, it will be appreciated that various changes and modifications may be made without departing from the scope of the invention, which is defined by the following claims.

1. A system for executing multifaceted, multiparty transactions on a blockchain distributed ledger network, comprising:
a plurality of computer systems participating as nodes in the blockchain distributed ledger network, each system including:
storage adapted to store the blockchain distributed ledger and one or more data models required for modeling a multifaceted multiparty transaction within the blockchain distributed ledger network; and
a processor for dynamically instantiating the one or more data models on participating computer system nodes to execute the multifaceted, multiparty transaction.

2. The system of claim 1, wherein the one or more data models are built from contract templates defining contract meta-data and formulas for calculations, and event templates defining triggering events which initiate a transaction between the multiple parties.

3. The system of claim 2, wherein the system is further configured to record the triggering and execution of each multifaceted, multiparty transaction as an immutable record in each instance of the blockchain distributed ledger network stored in each participating computer node.

4. The system of claim 2, wherein the system is configured to store the one or more data models as immutable records within the blockchain distributed ledger.

5. The system of claim 4, wherein the blockchain distributed ledger is permissioned to connect the multiple parties in a secure peer-to-peer network, and configured to share the one or more data models between the multiple parties to a contract defined by the one or more data models.

6. The system of claim 1, wherein the multifaceted, multiparty transaction is a contractual agreement between requiring a payment transaction between multiple parties.

7. The system of claim 6, wherein the payment transaction is one of a royalty payment and an interest payment, and any splitting of fractional or percentage payments as between the multiple parties are predefined by the one or more data models.

8. The system of claim 7, wherein the system is configured to initiate the payment transaction and any splitting of fractional or percentage payments between the multiple parties as defined by the one or more data models upon occurrence of a triggering event defined by the event template.

9. The system of claim 8, wherein the system is configured to automate the payment transaction upon occurrence of a triggering event and record the payments as immutable records in each instance of the blockchain distributed ledger of each participating computer node.

10. The system of claim 9, wherein the system is configured to settle any payment obligations between the multiple parties with a digital currency which is connected to the system and available to all participating parties.

11. A computer-implemented method of executing multifaceted, multiparty transactions on a blockchain distributed ledger network, comprising:
for each computer system participating as a node in the blockchain distributed ledger network, storing in storage the blockchain distributed ledger and one or more data models required for modeling a multifaceted multiparty transaction within the blockchain distributed ledger network; and
utilizing a processor of one more computer system participating as a node in the blockchain distributed ledger network, dynamically instantiating the one or more data models on participating computer system nodes to execute the multifaceted, multiparty transaction.

12. The method of claim 11, wherein the one or more data models are built from contract templates defining contract meta-data and formulas for calculations, and event templates defining triggering events which initiate a transaction between the multiple parties.

13. The method of claim 12, wherein the method further comprises recording the triggering and execution of each multifaceted, multiparty transaction as an immutable record in each instance of the blockchain distributed ledger network stored in each participating computer node.

14. The method of claim 12, wherein the method further comprises storing the one or more data models as immutable records within the blockchain distributed ledger.

15. The method of claim 14, wherein the method further comprises permissioning the blockchain distributed ledger to connect the multiple parties in a secure peer-to-peer network, and sharing the one or more data models between the multiple parties to a contract defined by the one or more data models.

16. The method of claim 11, wherein the multifaceted, multiparty transaction is a contractual agreement between requiring a payment transaction between multiple parties.

17. The method of claim 16, wherein the payment transaction is one of a royalty payment and an interest payment, and any splitting of fractional or payments as between the multiple parties are predefined by the one or more data models.

18. The method of claim 17, wherein the method further comprises initiating the payment transaction and any splitting of fractional or percentage payments between the multiple parties as defined by the one or more data models upon occurrence of a triggering event defined by the event template.

19. The method of claim 18, wherein the method further comprises automating the payment transaction upon occurrence of a triggering event and recording the payments as immutable records in each instance of the blockchain distributed ledger of each participating computer node.

20. The method of claim 19, wherein the method further comprises settling any payment obligations between the multiple parties with a digital currency which is connected to the system and available to all participating parties.
